(19) United States
(12) Patent Application Publication
(10) Pub. No.: US 2011/0032519 A1
(43) Pub. Date: Feb. 10, 2011

(54) SYSTEM FOR DETECTING THE INCLINATION OF LIGHT SOURCES, IN PARTICULAR OF PRECISION APPROACH SLOPE INDICATORS OF AN AIRPORT RUNWAY

(76) Inventors: Alberto Coletti, Rome (IT); Luigi Piccari, Rome (IT); Mario Zitelli, Rome (IT)

Correspondence Address: NEIFELD IP LAW, PC, 4813-B EISENHOWER AVENUE, ALEXANDRIA, VA, 22304, US

(21) Appl. No.: 12/536,248

(22) Filed: Aug. 5, 2009

(51) Int. Cl. G01B 11/26; G01C 9/06

(52) U.S. Cl. 356/139.1; 33/366.23

(57) ABSTRACT

The present invention relates to a system for detecting the inclination of one or more light beams, having at least one sharp colour transition, emitted by one or more light sources, in particular PAPIs or APAPIs, comprising measuring means (103) for measuring an inclination, and optoelectronic means (120, 121) for acquiring images which means are capable to be inclinated by first powered means (122), the inclination measuring means (103) being integrally coupled to optoelectronic means (120, 121) so as to measure the inclination of the latter, and wherein the system further comprises electronic processing means (62) capable to control the first powered means (122) an the basis of the images acquired by the optoelectronic means (120, 121) so that, when the system carries out a detection of the inclination of said one or more light beams, said at least one sharp colour transition appears in at least one corresponding predetermined position of said acquired images, said electronic processing means (62) reading an inclination value outputted by the inclination measuring means (103) for displaying the same on a display.

The present invention further relates to the related detecting process.

### REFERENCE TO COLOR DRAWINGS

The patent or application file contains at least one drawing executed in color. Copies of this patent or patent application publication with color drawing(s) will be provided by the Office upon request and payment of the necessary fee.

### DISCLOSURE

The present invention relates to a system for detecting the inclination of one or more light beams, having at least one sharp colour transition, emitted by light sources, in particular precision approach path indicators or PAPIs and abbreviated PAPI indicators or APAPI for airport landing runways, that is extremely precise, fast in detecting, reliable, simple, efficient, and inexpensive.

Preferably, the system according to the invention further allows to detect the azimuthal width and emitted light beam intensity. Moreover, the system according to the invention may further allow to detect the beam flatness, i.e. to check whether said at least one sharp colour transition is horizontal.

The present invention further relates to the related detection process.

The system according to the invention will be illustrated with reference, only by way of example and not by way of limitation, to an application of the same for detecting PAPI or APAPI lights of an airport runway. However, it must be considered that the system according to the invention may be also used for detecting inclination, and preferably also azimuthal width, intensity and flatness, of light sources of different type which are capable to emit one or more light beams having at least one sharp colour transition, still remaining within the scope of the present invention.

It is known that airports are provided with several instruments and apparatuses aiding pilots to correctly perform the various maneuvers of the aircrafts.

In particular, in case of landing maneuvers, the airports are provided with optical devices and, possibly, also with radio communication apparatuses for, respectively visual and instrumental, guidance of the pilot along the so called descent path (glide path) up to the landing runway.

The so called precision approach path indicator or PAPI systems and the abbreviated PAPI or APAPI (Abbreviated Precision Approach Path Indicator) systems are included among the most used visual guidance optical devices. The PAPI and APAPI systems have fundamental relevance in the context of air navigation, since, in appropriate visibility conditions, they are capable to provide the pilot with information on the descent angle related to the approaching runway. In fact, if the runway lights provide an alignment on the plane, the PAPI provides information on the third dimension, i.e. the elevation, having an extremely delicate role for air transport safety.

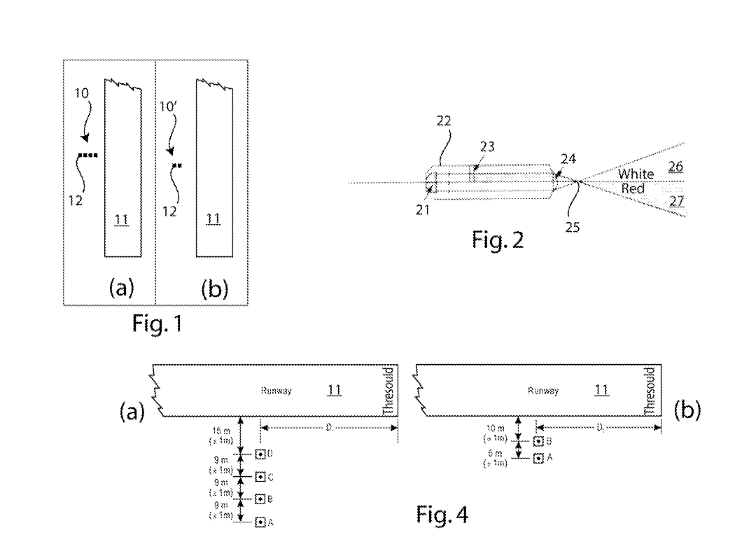

As shown in FIGS. 1a and 1b, a PAPI system and an APAPI system are provided with a bar (wing bar) 10 and 10′, respectively, that is transverse to the runway 11 and having, respectively, four or two multi-lamp units 12 equally spaced, each comprising two or three lamps. In some cases, the PAPI bars may be installed on both sides of the runway 11.

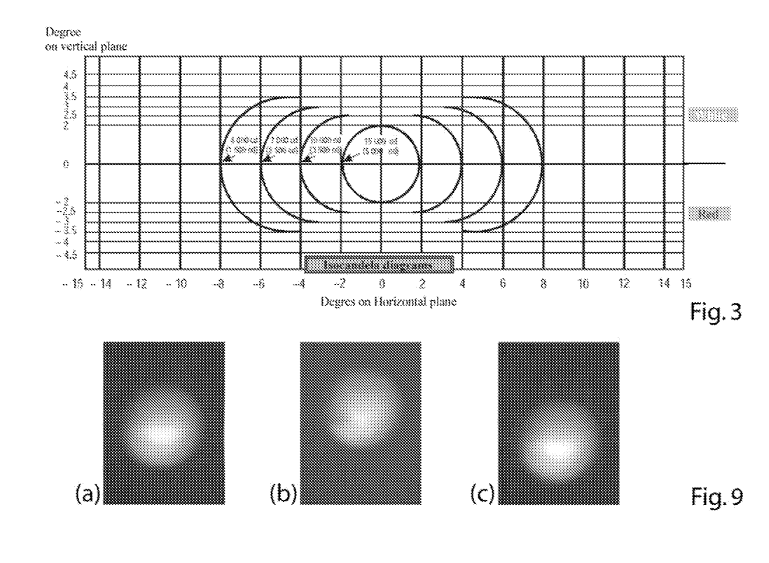

With reference to FIG. 2, each lamp 21 of a multi-lamp unit, housed within the unit case 22 and provided with a parabolic reflector, emits a white light beam the upper half of which passes through a red filter 23. The light beam exits the case passing through an output collimating lens 24 whereby beyond the focal point 25 of the lens 24 the beam upper half 26 is white whereas the lower half 27 is red. ICAO standards establish that the colour transition from red to white along the vertical plane is such as to appear to an observer, at a distance of at least 300 meters from the multi-lamp unit, within a vertical angle of not more than 3′. In particular, ICAO standards establish that the emitted beam must allow an operation of the PAPI or APAPI system both by day and night, and the light intensity distribution of the single units must be the one shown in FIG. 3, where curves indicate the minimum intensity of the red light of PAPI units, whereas the white one has a higher value by 2 to 6.5 times; values between brackets refer to APAPI units.

With reference to FIGS. 4a and 4b, ICAO rules establish that the PAPI and APAPI units are placed in the respectively illustrated configurations, with the indicated installation tolerances. The units are mounted so as to appear to the pilot as substantially placed on a horizontal line. In order to let the units be mounted at a level as low as possible and in order to permit any inclination in transverse direction, small adjustments of the unit heights are allowed (not larger than 5 cm). A side gradient not larger than 1.25% is acceptable, provided that it is uniformly applied to all the units.

In some cases a reduced spacing between PAPI units of 6 m (±1 m) is found, wherein the most internal unit is at 10 m (±1 m) from the runway edge.

Similarly, sometimes spacing between the two APAPI units may be increased up to coincide with the one of the PAPI units of FIG. 4a (i.e. equal to 9 m±1 m with the most internal unit being at 15 m±1 m from the runway edge).

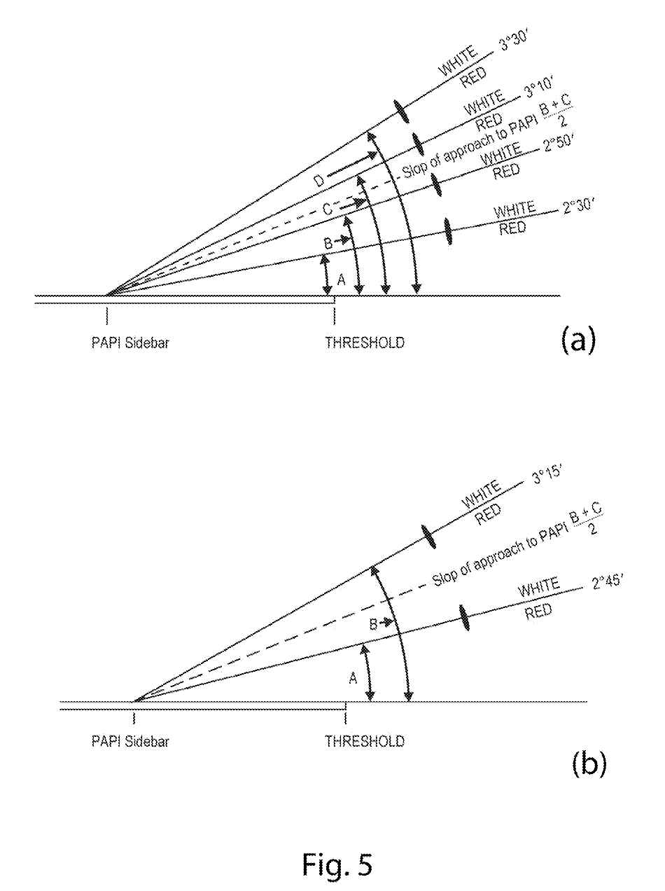

FIGS. 5a and 5b show the inclinations according to which ICAO rules establish that colour transitions, in the following also indicated as CTs, of the light beams exiting the single PAPI and APAPI units of FIGS. 4a and 4b, respectively, must be oriented. In some cases, when it is necessary to harmonize the PAPI system with an instrumental descent path guidance equipment, the gradients between the inclinations of the beams of the central PAPI units of FIG. 5a may increase from 20′ to 30′, whereby the inclinations of the four PAPI units vary from 2°25′ to 3°35′.

Considering that the ICAO rules establish that the optimal slope of the descent path that an aircraft must follow is equal to 3°, and that such slope is the mean of the inclinations of the single units, FIG. 5a shows that the PAPI bar is built and installed in such a manner that an approaching pilot will see:
with the right slope (equal to about)3°, the two units closer to the runway as red colour and the two units farther from the runway as white colour;
with larger slope than the right one, the unit closer to the runway as red colour and the other three units as white colour; with still larger slope all the units as white colour;
with lower slope than the right one, the three units closer to the runway as red colour and the unit farther from the runway as white colour; with still lower slope all the units as red colour.

In the cases where the PAPI bars are installed on both sides of the runway, the corresponding units are adjusted at the same elevation angle so that the signals of each bar symmetrically and simultaneously change.

Similarly, FIG. 5b shows that the APAPI bar is built and installed in such a manner that an approaching pilot will see:
with the right slope (equal to about)3°, the unit closer to the runway as red colour and the other one as white colour;
with larger slope than the right one, both units as white colour;
with lower slope than the right one, both units as red colour.

ICAO standards provide that each unit may be adjusted in elevation so that the lower limit of the white part of the beam may be placed at the desired elevation within the field from 1°30′ and at least 4°30′ above the horizontal.

As said before, according to ICAO rules, the CT may occupy an angle of 3′ without specifying which point of the transition must be considered as reference. An uncertainty of 3′ is neglectable in the elevation measurement that is of some degrees, but not in the differential measurement, that is of 20′ or 30′ depending on whether the PAPI bar is harmonized or not with an instrumental aid equipment. Since the differential measurement is obtained from the absolute elevation one precisions of 1′ on the elevation measurement are necessary for having a precision of 2′ on the differential measurement. This entails that it is needed to determine within the CT a precise reference point, that must be the same for all the measurements with a tolerance substantially lower than 1′.

Consequently, ICAO rules on maintenance of PAPI and APAPI lights is very stringent, providing for a periodic control of alignment of the single units (once per month) and for re-alignment of a unit when its deviation from the nominal value of beam inclination exceeds 1′ of degree.

Alignment during installation phase is typically carried out with a precision clinometer (generally more accurate than 1′) provided by the PAPI unit manufacturer and housed on a suitable reference plane. The same clinometer is used for periodic controls whereas the definitive test is constituted by the flight check.

The flight check entrusts the pilot's eye, and the targets detected through aeronautical theodolite on ground, with the check of the compliance of the PAPI or APAPI unit with the rules in force. The flight, performed with a specifically equipped aircraft and by suitable personnel, must be periodically carried out, and also in occasion of each intervention made on the units. According to the presently consolidated procedure the reference test is the one conducted by an airplane approaching from a distance larger than 2 km and, in order to make a ground measurement provide compliant data, it is convenient to analyze what the pilot sees from afar, e.g. from 4 km. At such a distance, the pilot is capable to see changes in colour, which may be also put in relationship with changes in intensity, and to distinguish the single units (but not the single 2 or 3 light beams coming from the single unit).

However, such instruments and procedures for controlling alignment of the beams emitted by the single units suffer from some significant drawbacks.

First of all, although extremely precise, the clinometer does not measure the inclination of the colour transition in the light beam, but only the inclination of the unit reference plane. If such reference plane moves, due to any reason, with respect to the optical sub-system (comprising lamp, parabolic reflector, red filter, and output lens) measurement becomes imprecise.

With regard to the flight check, first of all the pilot is not capable to resolve the small differences of height of the single lights. Hence what the pilot sees are only angular differences.

Moreover, each time that the approaching pilot, lowering his elevation, sees the colour transition on one of the units, he indicates this to ground and the airplane is sighted with an aeronautical theodolite measuring the angle under which the pilot sees that unit at the instant corresponding to the colour transition. This means that also the flight check does not provide much precise results, mainly because the pilot is unable to identify with absolute accuracy the colour transition, which should be detected by always assuming the same transition point for all the light beams, and the results may change by changing pilot, and even with the same pilot. This is further heightened in the case when the white-red step is not “clean”, as for instance occurs when the transition has anomalies due to constructive and/or calibration details.

Finally, the flight check is an extremely expensive procedure.

Some alternative solutions have been developed, which are based on trigonometric methods of measurements performed with instruments on ground for calculating the angle from distance and height linear measurements.

However, even these solutions suffer from important drawbacks, mainly due to the fact that the errors accumulate and it is in any case necessary the horizontal reference. In this regard, when the PAPI or APAPI units are located on an extremely uneven ground with depressions, measuring procedures are extremely complex in order to obtain a precise positioning with respect to the unit under measurement.

Consequently, such alternative solutions does not allow to satisfy the accuracy and precision required by ICAO rules.

Moreover, ICAO rules prescribe that, in some cases, also the width, on the horizontal plane, of the light beams emitted by the PAPI or APAPI bar is measured. Such measurement may be due to the need of reducing, in some cases, the beam width, mainly for avoiding that within the same possible obstacles are found during the descent phase. Also this check is carried out during the flight check, with the airplane transversely travelling and the pilot indicating to ground when he enters the lighting field of the PAPI or APAPI bar, so that the theodolite on ground may measure its inclination.

ICAO rules still prescribe that also the intensity of the light beams emitted by the PAPI or APAPI bar is measured, typically through ground photometric checks, providing the results as isocandela diagrams.

Hence, it is an object of the present invention to allow, an extremely precise, fast to execute, reliable, simple, efficient, and inexpensive detection of the inclination of one or more light beams, having at least one sharp colour transition, emitted by light sources, in particular PAPI or APAPI indicators for airport landing runways.

It is still an object of the present invention to further allow to detect the azimuthal width, the intensity and the flatness of the emitted light beam.

It is therefore specific subject matter of this invention a system for detecting the inclination of one or more light beams, having at least one sharp colour transition, emitted by one or more light sources, in particular precision approach slope indicators, comprising measuring means for measuring an inclination, and optoelectronic means for acquiring images which means are capable to be inclinated by first powered means, the inclination measuring means being integrally coupled to optoelectronic means so as to measure the inclination of the latter, and wherein the system further comprises electronic processing means capable to control the first powered means on the basis of the images acquired by the optoelectronic means so that, when the system carries out a detection of the inclination of said one or more light beams, said at least one sharp colour transition appears in at least one corresponding predetermined position of said acquired images, said electronic processing means reading an inclination value outputted by the inclination measuring means for displaying the same on a display.

Always according to the invention, the image acquiring optoelectronic means may include a measure camera, preferably comprising a CMOS sensor, still more preferably of 1280×1024 colour pixels, and provided with objective with single lens.

Still according to the invention, the first powered means is capable to carry out an inclination of the measure camera with about 0.3′ of resolution.

Furthermore according to the invention, the inclination measuring means may comprise a precision clinometer with single axis.

Always according to the invention, the system may comprise thermostatic means, preferably comprising a controlled temperature heater, controlled by the electronic processing means, capable to keep the inclination measuring means at a predetermined, preferably adjustable, temperature.

Still according to the invention, the electronic processing means may be capable to compensate a misalignment of the integral coupling between the inclination measuring means and the image acquiring optoelectronic means.

Furthermore according to the invention, the inclination measuring means, the image acquiring optoelectronic means, and the first powered means may be housed in a measurement head, mounted on a rough positioning apparatus, preferably a precision tripod, which measurement head further comprises self-leveling means, integrally coupled to the image acquiring optoelectronic means, capable to automatically provide a horizontal plane of absolute reference with respect to a geographical vertical line, whereby said inclination value is related to said reference horizontal plane.

Always according to the invention, the self-leveling means may comprise a reference plate, to which a double axis clinometer capable to detect an inclination of the plate about a pitch axis and a roll axis is integrally coupled, the system further comprising second powered means, controlled by electronic feedback controlling means on the basis of an inclination value outputted by the double axis clinometer, which electronic feedback controlling means is capable to rotate the plate about said pitch and roll axes.

Still according to the invention, the system may further comprise third powered means, controlled by the electronic processing means, capable to rotate the image acquiring optoelectronic means about a vertical axis orthogonal to a reference horizontal plane, whereby the third powered means is capable to control a steering orientation of the image acquiring optoelectronic means.

Furthermore according to the invention, the system may further comprises fourth powered means, controlled by the electronic processing means, capable to control a vertical position of the image acquiring optoelectronic means.

Always according to the invention, the image acquiring optoelectronic means may further include a panning camera integrally coupled to the measure camera, and the electronic processing means may control the first powered means first on the basis of the images acquired by the panning camera and then, once said one or more light beams appear in the images acquired by the panning camera, on the basis of the images acquired by the measure camera.

Still according to the invention, the electronic processing means may be capable to display on said display indications related to a correction of an inclination of said one or more light sources.

Furthermore according to the invention, the electronic processing means may be capable to measure an intensity of said one or more light beams on the basis of the images acquired by the optoelectronic means.

Always according to the invention, the electronic processing means may be capable to measure an orientation of said at least one sharp colour transition in at least one of said images acquired by the optoelectronic means.

It is still specific subject matter of this invention a process for detecting the inclination of one or more light beams, having at least one sharp colour transition, emitted by one or more light sources, in particular precision approach slope indicators, comprising the following steps:
acquiring images of said one or more light beams through optoelectronic means;
processing said images for checking whether said at least one sharp colour transition appears in at least one corresponding predetermined position thereof;
in the case where said at least one sharp colour transition does not appear in said at least one corresponding predetermined position, controlling first powered means so as to modify an inclination of the optoelectronic means; and
in the case where said at least one sharp colour transition appears in said at least one corresponding predetermined position, measuring an inclination value of the optoelectronic means.

Always according to the invention, the process may further comprise the following step:
displaying said inclination value on a display.

Still according to the invention, the process may further comprise the following preliminary step:
controlling further powered means for positioning the optoelectronic means so as to shot said one or more light beams.

Furthermore according to the invention, the optoelectronic means may comprise a panning camera and a measure camera, and in the preliminary step images acquired by the panning camera may be processed for checking that said one or more light beams appear therein, whereas the subsequent processing for checking whether said at least one sharp colour transition appears in at least one corresponding predetermined position thereof may be carried out on images acquired by the measure camera.

Always according to the invention, the process may further comprise the following step:
displaying on a display indications related to a correction of an inclination of said one or more light sources.

Still according to the invention, the process may further comprise the following step:
measuring an intensity of said one or more light beams on the basis of the images acquired by the optoelectronic means.

Furthermore according to the invention, the intensity of said one or more light beams may be measured in a plurality of angles between the optoelectronic means and said one or more light sources, and the process may further comprise the following step:
interpolating the intensities measured with a reference intensity diagram, preferably in proximity to said at least one sharp colour transition.

Always according to the invention, said light beams may be at least two, and the process may further comprise the following step:
summing the interpolated intensity diagrams of all the light beams, for obtaining an intensity diagram of said one or more light sources.

Still according to the invention, the process may further comprise the following step:
processing a width of said one or more light beams on a horizontal plane.

Furthermore according to the invention, the process may further comprise the following step:
measuring an orientation of said at least one sharp colour transition in at least one of said images acquired by the optoelectronic means.

### BRIEF DESCRIPTION OF THE DRAWINGS

The present invention will be now described, by way of illustration and not by way of limitation, according to its preferred embodiments, by particularly referring to the Figures of the enclosed drawings, in which:

FIG. 1 shows a schematic top view of PAPI and APAPI bars;

FIG. 2 shows a schematic sectional view of a PAPI or APAPI unit;

FIG. 3 shows an isocandela diagram of light intensity of PAPI and APAPI units;

FIG. 4 shows a schematic top view of the configurations of the PAPI and APAPI bars;

FIG. 5 shows a schematic side view of the CTs of the PAPI and APAPI bars;

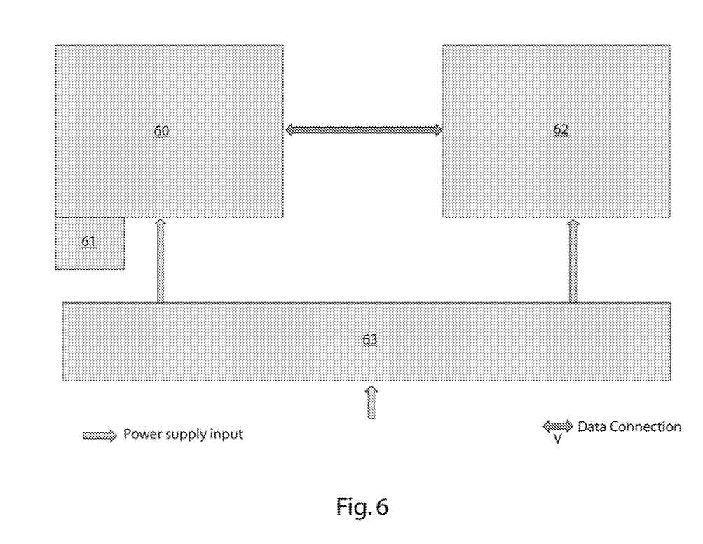

FIG. 6 shows a schematic block diagram of a preferred embodiment of the system according to the invention;

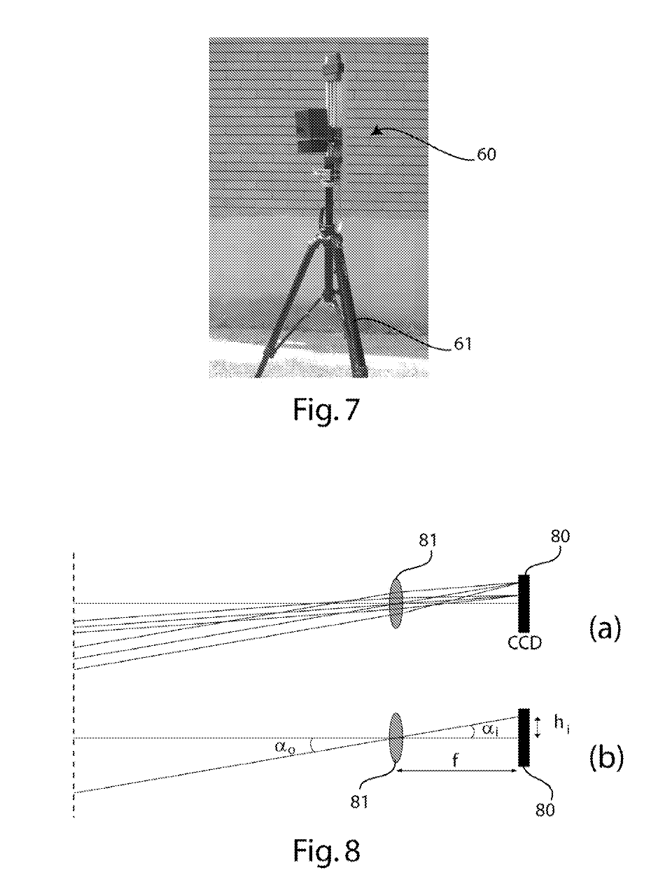

FIG. 7 shows a perspective view of a portion of the system of FIG. 6;

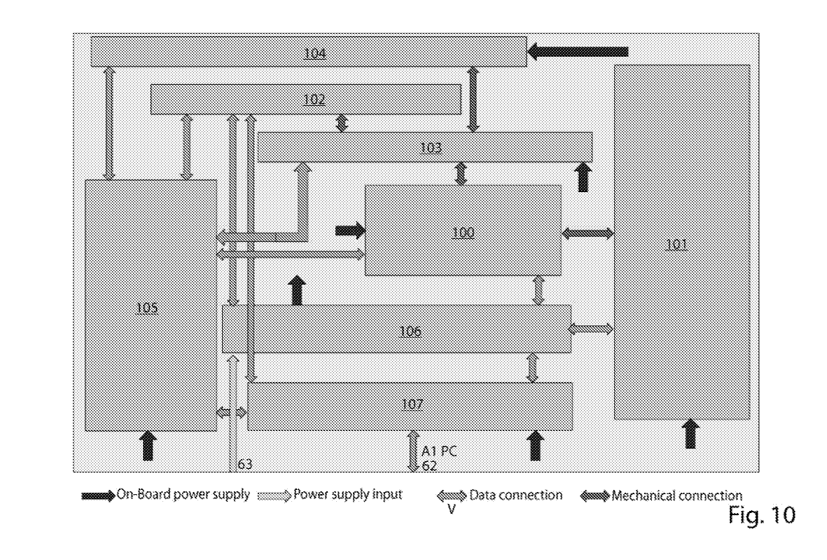

FIG. 8 shows a schematic representation of the detection by the measure camera of the system of FIG. 6;

FIG. 9 shows three images acquired by the measure camera of the system of FIG. 6 for three different alignments of a light beam under measure;

FIG. 10 shows a schematic block diagram of a first portion of the system of FIG. 6;

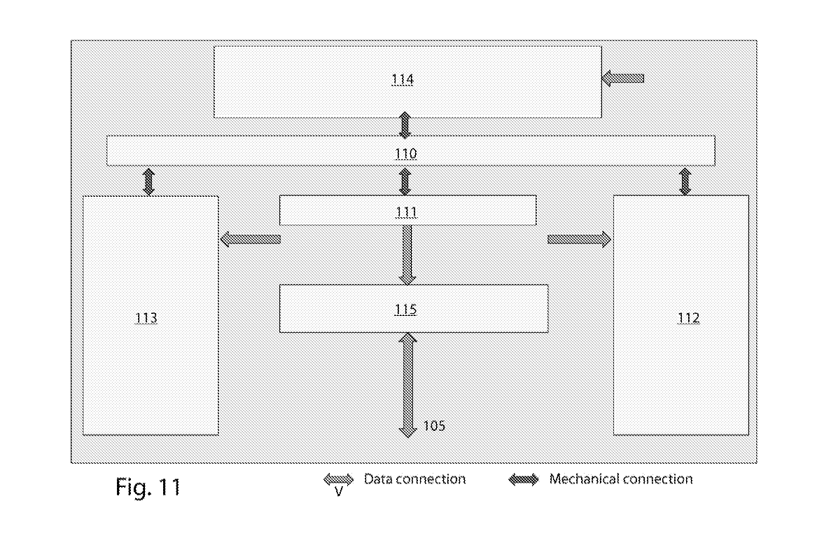

FIG. 11 shows a schematic block diagram of a second portion of the system of FIG. 6;

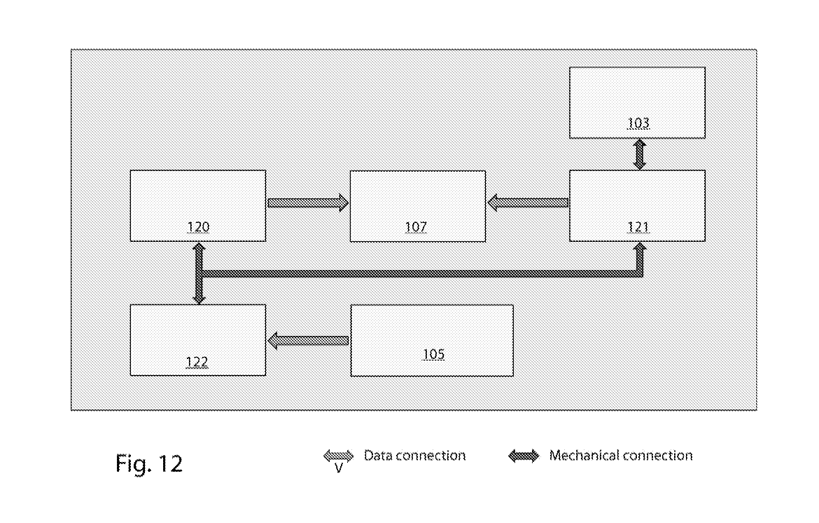

FIG. 12 shows a schematic block diagram of a third portion of the system of FIG. 6;

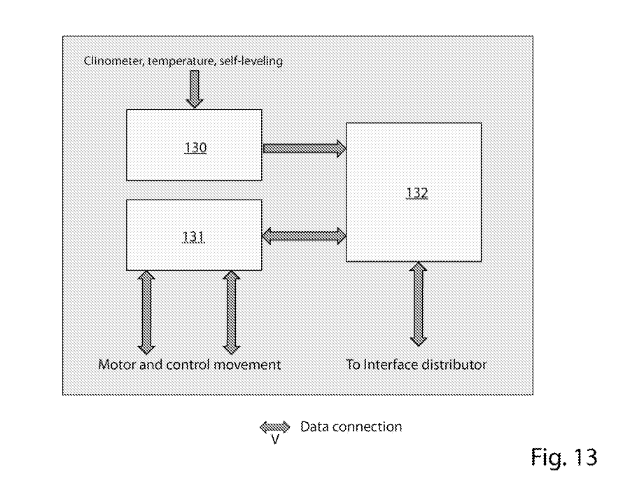

FIG. 13 shows a schematic block diagram of a fourth portion of the system of FIG. 6; and

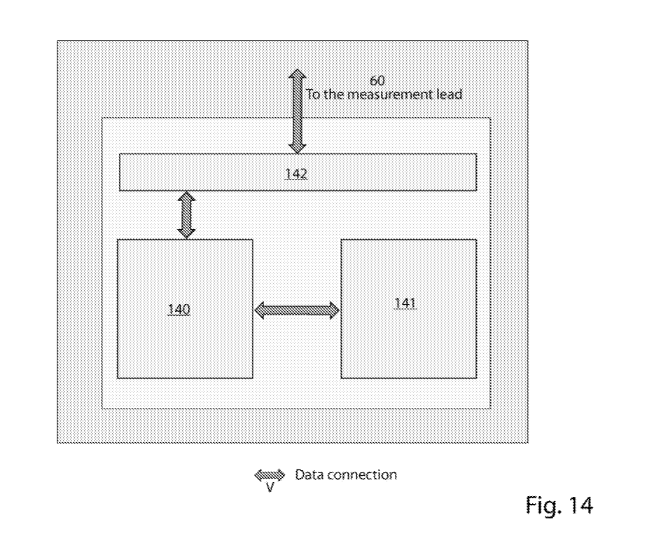

FIG. 14 shows a schematic block diagram of a fifth portion of the system of FIG. 6.

### DETAILED DESCRIPTION

In the Figures, identical reference numbers are used for alike elements.

FIG. 6 shows a general block diagram of the detection system according to the invention, comprising a measurement head 60, mounted on an rough positioning apparatus 61, connected to a processing unit 62, preferably a portable PC, capable to process detection data provided by the head 60 and to control fine positioning of the same head. The measurement head 60 and the unit 62 are supplied by a power supply unit 63, preferably at 12 VDC, more preferably provided by an external battery (still more preferably rechargeable) and/or by a vehicle battery.

Preferably, the rough positioning apparatus 61 comprises a support tripod having a very good precision to which the measurement head 60 is attached as shown in FIG. 7.

The measurement head 60 is provided with a plurality of optoelectronic sensors capable to measure alignment parameters of the light beams generated by the PAPI or APAPI unit under measure.

The system according to the invention, instead of calculating the inclination angle of the beam on the basis of distance and height linear measurements, exploits the lens property of making a transformation from angles to positions.

FIG. 8 schematically shows such transformation from angles to positions. In particular, the measurement head 60 uses a measure camera comprising preferably a CMOS sensor 80 with infinity focusing and objective with single lens 81: it results from this that the position of each element or pixel of the digital image detected by the measure camera is related to the angle under which the camera sees the observed point corresponding to the pixel. Once the light beam under measurement is shot by the measure camera, knowing the absolute spatial orientation of the camera with respect to the horizontal line, the processing unit 62 is capable to obtain the angular elevation of the line joining the optical center of the lens 81 with the lamp generating the light beam under measurement.

In carrying, out a detection, the PAPI or APAPI unit under measurement is preferably at a distance of at least 10 meters from the measurement head 60, whereby, as shown in FIG. 8(a), rays through the objective lens 81 may be considered as parallel and the angles may be considered as small. The first condition is still more met considering that the light beam of a PAPI or APAPI unit is collimated, and hence the rays are almost parallel at any distance.

As shown in FIG. 8(b), the angles of αₒᵣ and αᵢ which are formed with respect to the optical axis of the sensor 80 by a light ray 82 respectively before and after the lens 81 are equal, thereby it follows that:

αₒᵣ=arctan(hᵢ/f)

where:

hᵢ is the height of the pixel corresponding to the ray 82, and

f is the known distance between sensor 80 and lens 81.

Making reference also to FIG. 2, during detection, the system according to the invention focuses the red filter 23 internal to the PAPI or APAPI unit, the edge of which generates the CT. The beam rays are made parallel by the output lens 24. The focal plane of the CMOS sensor 80 is exactly placed at the focal distance of the lens 81.

Since the output lens 24 of the unit under measurement creates an image of the lamp 21 slightly moved forward (about 0.5-1 m) of the same PAPI or APAPI unit, the image of the filter 23 is less clear, because the one of the lamp 21 forms slightly behind the CMOS sensor 80. The processing unit 62 preferably processes the image so as to correct such defect.

FIG. 9 schematically shows the (reversed) images which form on the CMOS sensor 80 when placement and inclination of the CT of the light beam under measurement vary with respect to the optical axis of the measure camera with a simple objective with single lens 81.

As shown in FIG. 9(a), a light beam perfectly aligned with the optical axis of the measure camera of the measurement head 60 creates a circle the center of which is at central height of the digital image detected by the CMOS sensor 80 with one half that is red and the other half that is white. Obviously, in case of PAPI or APAPI unit with two or three beams, the digital image detected by the CMOS sensor 80 comprises two or three circles the centers of which lie at central height of the same image.

As shown in FIG. 9(b), parallel movements of the optical axis of the light beam under measurement downward (or upward) move the circle but not the CT line that remains in the image center. In other words, the digital image comprises an off-center circle with a red portion and a white portion, remaining the CT separation in the image center.

As shown in FIG. 9(c), angular movements of the light beam, the optical axis of which still passes through the center of the lens 81, move the whole circle from the height center of the digital image detected by the CMOS sensor 80, including the red-white separation that remains in the circle center. Obviously, if the optical axis of the light beam does not passes through the center of the lens 81, the CT would not be at the height center of the digital image nor in the circle center.

Obviously, in case of detection of light sources generating light beams having a not centered CT, or having a different number of CTs, the alignment corresponds to a correspondingly different configuration of the light beam image detected by the measure camera.

FIG. 10 shows in greater detail the components of the measurement head 60 of the preferred embodiment of the system according to the invention. In particular, the measurement head comprises a self-leveling base 100, mounted on the rough positioning apparatus 61 (see FIGS. 6 and 7), that supports the whole measurement head. A vertical movement unit 101 controls the position of the self-leveling base 100.

The measurement head further comprises an alignment optical unit 102 (comprising the measure camera sketched in FIG. 8) provided with powered movement means (illustrated below) for moving with respect to the self-leveling base 100; the optical unit 102 is integrally coupled to a detecting unit 103 for measuring inclination, preferably provided with a precision clinometer. A thermostatic unit 104 controls temperature of the inclination measuring unit 103. The measurement head further comprises a data acquisition unit 105, connected to the self-leveling base 100, to the optical unit 102, to the detecting unit 103 and to the thermostatic unit 104 with which it is capable to exchange data. Moreover, the measurement head comprises a controlling unit 106 for controlling motors for positioning the measurement head and its components, which controlling unit is capable to exchange data with the self-leveling base 100, the vertical movement unit 101, and the optical unit 102. Finally, the measurement head comprises a data distributing interface unit 107, capable to exchange data and signals with the alignment optical unit 102, with the data acquisition unit 105, and with the motor controlling unit 106, which distributing unit 107 is connected with the processing unit 62 for exchanging data and control signals. The external power supply to the measurement head comes from the power supply unit 63; preferably, the external power supply directly provides the power supply for the motor controlling unit 106 and for a local unit (not shown) for regulating the power supply, that in turn provides the power supply for the self-leveling base 100, for the vertical movement unit 101, for the detecting unit 103, for the thermostatic unit 104, for the data acquisition unit 105, and for the distributing unit 107.

The vertical movement unit 101 preferably comprises a slide bearing with runner dragged by a screw shaft on which the measurement head is attached. The slide bearing is preferably moved by a motor drive, slaved to a control electronic apparatus, possibly coinciding with the motor controlling unit 106, capable to move the measurement head upward or downward up to bring the light beam to measure within the sight field of the measure camera. The slide bearing is preferably provided with stop devices, for protecting motors, made by means of microswitches or other similar devices.

The self-leveling base 100 is capable to automatically provide a horizontal plane of absolute reference with respect to the geographical vertical line, so as to allow the system according to the invention to detect the absolute inclination of the measure camera and, consequently, of the light beams under measurement with respect to the geographical horizontal line.

With reference to FIG. 11, it may be observed that the self-leveling base 100 comprises a plate 110 operating as reference surface, to which a double axis clinometer 111, preferably having high precision, is integrally coupled, that is capable to detect the inclination of the plate 110 about the pitch and roll axes. A first and a second powered apparatuses 112 and 113 are coupled to the plate 110, which apparatuses are capable to rotate the plate 110 about two respective rotation axes: a first axis of pitch, i.e. a transverse rotation axis, orthogonal to the longitudinal axis of the plate 110 and lying on the plane of the plate 110, thereby the first powered apparatus 112 controls the pitch inclination of the plate 110; a second axis of roll, i.e. a longitudinal rotation axis of the plate 110, thereby the second powered apparatus 113 controls the roll inclination of the plate 110. A third powered apparatus 114 is also coupled to the plate 110, which apparatus preferably exchanges data with the data acquisition unit 105 and which is capable to rotate the plate 110 about a third axis orthogonal to the other two axes, i.e. parallel to the vertical axis that is orthogonal to the horizontal plane of the plate 110, thereby the third powered apparatus 114 controls the steering orientation of the plate 110 (and of the measure camera).

Finally, the self-leveling base 100 comprises an electronic feedback control unit 115, connected for exchanging data to the double axis clinometer 111, to the two powered apparatuses 112 and 113, and to the data acquisition unit 105. Since, as it will be explained in detail below, the system according to the invention carries out the detection by aligning the optical axis of the measure camera to the optical axis of the light beam (or light beams) under measurement, the electronic feedback unit 115 is constantly active, thereby the base 100 continuously adjusts its own orientation for compensating possible small movements caused by accidental impacts, wind or other external factors during detection.

Self-leveling may be disabled through an external control, preferably imparted by the control software performed by the processing unit 62, e.g. for allowing the apparatus to be moved from one detection to the other.

With reference to FIG. 12, it may be observed that the alignment optical unit 102 comprises a first so-called panning camera 120 with sufficiently wide angular sight field to allow an easy shot of the PAPI or APAPI unit under measurement (when the system according to the invention is placed at a sufficient operating distance). The panning camera 120 is slaved to a third powered apparatus 122 of training capable to rotate the panning camera 120 about a pitch axis, i.e. a transverse rotation axis, orthogonal to the optical axis of the panning camera 120, thereby the third powered apparatus 122 controls the pitch inclination of the panning camera 120. The third powered apparatus 122 is controlled, through the data acquisition unit 105 and the distributing unit 107, by the processing unit 62 so that the light beam (or light beams) of the PAPI or APAPI unit under measurement may be brought in the center of the image detected by the panning camera 120. At this point, the light beam (or light beams) of the PAPI or APAPI unit under measurement will appear also in the digital image detected by a second measure camera 121, with which the optical unit 102 is provided, that is integrally coupled to the panning camera 120 (and it is hence subject to the same movements imparted to the panning camera 120).

Also making reference to FIGS. 2 and 8, the measure camera 121 preferably comprises a CMOS sensor 80 of 1280×1024 colour pixels and it is provided with an objective with single lens 81 with such characteristics as to form a transformed image of the light beam (or light beams) emitted by the PAPI or APAPI unit under measurement wherein the angular coordinates' of the object plane containing the red filter 23 of the unit are transformed in orthogonal Cartesian coordinates on the plane of the CMOS sensor 80. As said, the third training powered apparatus 122 further controls, preferably with high resolution, the inclination of the measure camera 121 (along with the panning camera 120), making it rotate about a pitch axis, i.e. a transverse rotation axis, orthogonal to the optical axis of the second camera 121. In order to adjust the inclination of the measure camera 121 with high resolution, the third powered apparatus 122 is controlled, through the data acquisition unit 105 and the distributing unit 107, by the processing unit 62 so that the light beam (or light beams) of the PAPI or APAPI unit under measurement may be brought in the center of the image detected by the second camera 121: with successive iterations processed by the processing unit 62, the white-red separation line is brought to coincide with the horizontal line passing through the center of the CMOS sensor 80 so that the two, respectively, white and red semicircles of the beam have equal area, thereby indicating that the optical axis of the measure camera 121 is perfectly aligned with the optical axis of the light beam exiting from the PAPI or APAPI unit under measurement. For obtaining high precisions, the measure camera 121 incorporates an objective with extremely precise single lens 81, whereas the third training powered apparatus 122 is capable to carry out a very fine vertical inclination of the measure camera 121 (and consequently of the panning camera 120), preferably with a resolution of about 0.3′, so that the processing unit 62 is capable to recognize when the red-white separation line is exactly in the center of the CMOS sensor 80.

In particular, the first and second cameras 120 and 121 preferably transmit the data of the directly detected images to the distributing unit 107. The third powered apparatus 122 is controlled by the motor controlling unit 106.

The detecting unit 103 for measuring inclination is preferably provided with a single axis precision clinometer for military and aerospace use capable to output a voltage proportional to the inclination angle with respect to the geographical horizontal plane. The clinometer is integrally coupled to the objective of the measure camera 121 so that its output directly measures the inclination of the optical beam when the second camera 121 is perfectly aligned with the same. Small mechanical defects actually avoid to make the clinometer perfectly aligned with the second camera 121, whereby the constructive misalignment is measured in phase of calibration of the system according to the invention and it constitutes one of the correction factors applied by the processing unit 62 to the performed detections.

The thermostatic unit 104 preferably comprises a controlled temperature heater that is wound around the precision clinometer of the inclination measuring unit 103 so as to keep it during operation at a predetermined temperature, that is established depending the geographical region of use of the system according to the invention and at which processing performed by the unit 62 is further adjusted. In particular, the clinometer is set at temperature during the start phase of the measurement campaign on the whole PAPI or APAPI bar and this ensures the effective correspondence between measured angles and output voltages as indicated in a calibration certificate of the precision clinometer. The operation temperature is constantly measured by the thermostatic unit 104 for avoiding that wrong measurement values are provided. The processing unit 62, through the data acquisition unit 105 and the distributing unit 107, receives the detected temperature data and controls the heater, preferably generating possible warnings for detections carried out with the clinometer of the unit 103 that has not yet reached the operation temperature or that is above the same due to external causes, such as direct solar radiation on the measurement head 60.

With reference to FIG. 13, it may be observed that the data acquisition unit 105 comprises a bank 130 of A/D converters having high precision and stability, preferably at 16 bits, which receive and digitize the analog outputs coming from the clinometer of the inclination measuring unit 103, from the thermostatic unit 104, and from the double axis clinometer of the self-leveling base 100. Moreover, the data acquisition unit 105 comprises a digital I/O bank 131 for the exchange of controlling and monitoring signals with the same units 103, 104 and 100, as well as with the powered apparatus 122 of the alignment optical unit 102. The two banks 130 and 131 are connected to a board 132 for storing the data, which may be read by the processing unit 62, that preferably drives the banks 130 and 131 through a high speed serial channel.

The data distributing interface unit 107, implemented as a hub, is capable to multiplex on the same transmission means all the data which are exchanged between the measurement head 60 and the processing unit 62 so that the interconnection occurs via single cable or a sole wireless channel. By way of example, the distributing unit 107 may comprise a USB hub on one side of which the panning camera 120, the measure camera 121, the data acquisition banks 130 and 131 and the motor controlling unit 106 are connected and on the other side of which the processing unit 62 (preferably a portable PC) is connected.

With reference to FIG. 14, it may be observed that the processing unit 62, that controls the whole system, comprises a controlling and processing sub-unit 140, that is capable to perform an analysis of the detected images, a driving of the measurement head motors, and the reading of the data stored in the board 132 of the data acquisition unit 105. The logic architecture further comprises a memory unit 141, memorizing a database for storing the identification and historical data of the performed detections, and an interface unit 142 for controlling the measurement head. The processing unit 62 is connected to the measurement head 60 preferably via a high speed serial port of USB 2.0 type.

In particular, the sub-unit 140 is preferably provided with a software that is capable to control detections in a completely automatic manner through the following steps:
selecting from (or creating in) the database 141 apparatus data related to type and characteristics of the PAPI or APAPI unit under measurement (e.g.: number of lamps, power, adjustments, etc.);
inputting distance and other variable parameters of the measurement (e.g.: PAPI turn-on power, measurement data, operator, etc.);
controlling the vertical slide of the height adjusting unit 101, that is set halfway as initial position;
controlling the powered apparatuses for moving the self-leveling base 100 and the alignment optical unit 102, which are set at gravitational horizontal level, through a local control, preferably capable to compensate at least 10°, more preferably with a precision of about 10′;
receiving controls selected by an operator (preferably through suitable selectable controls on a graphical interface displayed on a display—not shown—connected to the processing unit 62) for controlling the powered apparatuses for moving the measurement head, which must be set at an elevation adapted to shot the light beams emitted by the unit under measurement and which must be oriented for centering such beams in the image detected by the panning camera 120; at this point the beams also appear in the image detected by the measure camera 121, the sight field of which is preferably equal to about 3°;
starting the automatic execution of the measurement, preferably upon selection by the operator of a button on the graphical interface, when the detected image of the beam contains both the red and the white;
automatically controlling the powered apparatuses for moving the measurement head up to have an image as close as possible to the ideal one (i.e. with the light beams detected as circles centered in the image of the measure camera 121 with the CT in the center thereof);
once such alignment has been obtained, reading the inclination value provided by the precision clinometer of the detecting unit 103;
preferably, on the basis of the read value, displaying indications for correcting the inclination of the unit under measurement for making it comply again with the ICAO specification;
preferably, upon control by the operator, storing the measurement data in the database 141.

Preferably, the software performed by the sub-unit 140 also executed an operation diagnosis of the system according to the invention. In particular, it allows, in case of fault or malfunction, to proceed to a series of tests for determining the fault or malfunction.

Positioning the measure camera 121 with high precision is obtained through feedback signals generated by the software executed by the sub-unit 140 for analyzing the digital image detected by the same camera.

It is important to underline that, since the system according to the invention directly measures the light beam inclination, the geometric distance of the system from the unit under measurement does not intervene in calculations. This entails that the measurement head may be positioned anywhere, preferably choosing a minimum distance of about 10 meters. The maximum distance is given by the need of intercepting a beam that, according to the present ICAO standard, is normally inclinated at most by 3°35′ upward (see FIG. 5a), thereby, assuming that the maximum elevation at which the measurement head may be positioned is 200 cm, the maximum distance is equal to about 20 meters. Obviously, in case of larger or lower inclinations, upon equal elevation the maximum distance decreases or increases, respectively.

As shown in FIG. 8, the system carries out the detection by starting from such an alignment of the measurement head 60 that the CMOS sensor 80 of the measure camera 121 is perfectly vertical with respect to the reference horizontal plane. The self-leveling base 100 of the measurement head allows to meet this condition even though the rough positioning apparatus 61, preferably a precision tripod, is on hilly ground.

The processing unit 62 carries out an analysis of the digital image coming from the measure camera 121, capable to measure the zenith angle through purely gravitational, instead of trigonometric, methods and to display indications on a display for correcting and centering the PAPI or APAPI unit under measurement. The whole measuring system is completely automated, the operator being only required to make the initial positioning, both in horizontal and in vertical, with respect to the PAPI to measure.

For carrying out a detection of the inclination of two or three light beams emitted by a PAPI or APAPI unit, the system is preferably placed at a distance ranging from 10 to 20 meters from the unit under measurement and at an height ranging from 100 to 200 cm through the use of the rough positioning apparatus 61, preferably a precision tripod.

Once the operator has manually brought the measurement head 60 at the height needed to shot the light beam to measure, he may carry out further fine adjustments by moving the measurement head through the software of the processing unit 62, by preferably interacting with a graphical interface displayed on the display. The panning camera 120 aids the operator for carrying out the initial alignment. When the image of the PAPI or APAPI unit appears in a measuring window displayed by the graphical interface on the display, i.e. when the light beams are shot by the measure camera 121, the operator may start the automatic detection.

In this regard, the system according to the invention performs a repetitive sequence of the following steps:
acquiring the digital image of the beams by the measure camera 121;
analyzing the digital image by the processing unit 62; and
generating by the processing unit 62 signals for controlling the powered apparatus 122 for training the measure camera 121 for adjusting the alignment of the camera optical axis so as to make it get closer to the one of the light beams (i.e. for obtaining the detected light beams as circles centered in the image of the measure camera 121 with the CT in the center thereof).

When the processing unit 62 recognizes that the current alignment of the measure camera 121 is the optimal one, it reads (through the data acquisition unit 105) the precision clinometer of the detecting unit 103 for measuring the inclination, integral with the measure camera 121, the value of which corresponds to the beam inclination.

At this point, the processing unit 62 displays on the display indications for correcting the inclination of the PAPI or APAPI unit under measurement, allowing to intervene on the unit adjusting registers up to obtain an alignment complying with the specification. Preferably, such indications comprise the corrections to make on the several adjusting screws of the PAPI or APAPI unit under measurement.

Furthermore, the system according to the invention allows to detect the flatness of the light beam under measurement, checking whether the CT is horizontal, i.e. parallel to the plane of the plate 110 (operating as reference surface) of the self-leveling base 100.

Moreover, the system according to the invention allows to carry out a measure of the width, on the horizontal plane, of the light beams emitted by the PAPI or APAPI units.

Since the light beam horizontal width is typically of about 16°(see FIG. 3) the measure camera 121 is not capable to collect the whole beam, since the objective preferably has a width of the order of some tenths of degrees. Consequently, in order to obtain the beam width by processing the image detected during the inclination measurement, the width is obtained starting from samples of the intensity emitted by the single lights of a PAPI or APAPI unit as measured under several angle. For each model of PAPI or APAPI unit present in the database 141; it is then possible to interpolate the performed measurements with the typical intensity contour (shown in FIG. 3) for obtaining the continuous profile of the intensity. Once this processing has been simultaneously performed for each light, by summing in incoherent manner all the intensity diagrams the whole diagram of the PAPI or APAPI unit under measurement is obtained. The processing is performed for both white and red, in proximity to the CT separation line.

Operatively, the measurement is carried out by being at known distance (e.g. at 10 m) from the PAPI or APAPI unit under measurement, in substantially normal position, without needing the preliminary knowledge of the distance with high precision (hence exploiting common measuring instruments, such a tape measure). A measurement similar to the elevation one, possibly also with a lower accuracy, is carried out for aligning the measure camera 121 on the white/red separation line of the unit under measurement. The illuminance of the white and red parts is measured from the detected image. The measurement is repeated by moving right and left by known amounts: at the end of the measurement cycle the whole radiance diagram of the unit and the diagram width in predetermined points (e.g. at −6 dB and −20 dB) are processed.

Furthermore, the system according to the invention allows to measure the intensity of the light emitted by the PAPI or APAPI bar for checking the compliance with ICAO rules, preferably providing the results as isocandela diagrams (generally ellipses) similar to those of FIG. 3. Preferably, such detection is carried out simultaneously to the beam azimuth width detection, of which the first one uses the same measurements.

The advantages offered by the system according to the invention are evident and significant.

The system according to the invention is capable to measure with extreme precision, within 1′ of degree, the inclination of the colour transition of each single PAPI or APAPI unit or even of each single lamp within the unit, not suffering from the errors which impair traditional trigonometric methods. In particular, the system restores on ground, in conditions of “close field”, the pilot's sight in determining the elevation angle of the colour transition of the unit under measurement. This is possible since the measurement head at the beginning of the procedure self-levels, setting on the gravitational horizontal plane, similarly to what occurs during the “flight check”. The whole measurement procedure does not typically exceed 15 minutes and it may be carried out in any weather condition and in any climate, the system being thermally stabilized, preferably avoiding conditions, such as direct summertime solar radiation, which may cause excessive temperatures on the apparatus.

The system according to the invention is capable to reliably operate even on very uneven grounds with depressions.

Moreover, the system according to the invention is further capable to measure with good precision the azimuthal width of the beam of each single unit, the value of the intensity of the emitted light, and the beam flatness.

Therefore, the system according to the invention makes the expensive and complex “flight check” necessary only for checking that the corrections made on the basis of the results provided by the system have effectively made the PAPI or APAPI units comply with the ICAO rules.

The preferred embodiments have been above described and some modifications of this invention have been suggested, but it should be understood that those skilled in the art can make variations and changes, without so departing from the related scope of protection, as defined by the following claims.

1. System for detecting the inclination of one or more light beams, having at least one sharp colour transition, emitted by one or more light sources, in particular precision approach slope indicators, comprising measuring means for measuring an inclination, and optoelectronic means for acquiring images which means are capable to be inclinated by first powered means, the inclination measuring means being integrally coupled to optoelectronic means so as to measure the inclination of the latter, and wherein the system further comprises electronic processing means capable to control the first powered means on the basis of the images acquired by the optoelectronic means so that, when the system carries out a detection of the inclination of said one or more light beams, said at least one sharp colour transition appears in at least one corresponding predetermined position of said acquired images, said electronic processing means reading an inclination value outputted by the inclination measuring means for displaying the same on a display.

2. System according to claim 1, wherein the image acquiring optoelectronic means includes a measure camera, preferably comprising a CMOS sensor, still more preferably of 1280×1024 colour pixels, and provided with objective with single lens.

3. System according to claim 2, wherein the first powered means is capable to carry out an inclination of the measure camera with about 0.3′ of resolution.

4. System according to claim 1, wherein the inclination measuring means comprises a precision clinometer with single axis.

5. System according to claim 1, wherein it further comprises thermostatic means, preferably comprising a controlled temperature heater, controlled by the electronic processing means, capable to keep the inclination measuring means at a predetermined, preferably adjustable, temperature.

6. System according to claim 1, wherein the electronic processing means is capable to compensate a misalignment of the integral coupling between the inclination measuring means and the image acquiring optoelectronic means.

7. System according to claim 1, wherein the inclination measuring means, the image acquiring optoelectronic means, and the first powered means are housed in a measurement head, mounted on a rough positioning apparatus, preferably a precision tripod, which measurement head further comprises self-leveling means, integrally coupled to the image acquiring optoelectronic means, capable to automatically provide a horizontal plane of absolute reference with respect to a geographical vertical line, whereby said inclination value is related to said reference horizontal plane.

8. System according to claim 7, wherein the self-leveling means comprises a reference plate, to which a double axis clinometer capable to detect an inclination of the plate about a pitch axis and a roll axis is integrally coupled, the system further comprising second powered means, controlled by electronic feedback controlling means on the basis of an inclination value outputted by the double axis clinometer, which electronic feedback controlling means is capable to rotate the plate about said pitch and roll axes.

9. System according to claim 1, wherein it further comprises third powered means, controlled by the electronic processing means, capable to rotate the image acquiring optoelectronic means about a vertical axis orthogonal to a reference horizontal plane, whereby the third powered means is capable to control a steering orientation of the image acquiring optoelectronic means.

10. System according to claim 1, wherein it further comprises fourth powered means, controlled by the electronic processing means, capable to control a vertical position of the image acquiring optoelectronic means.

11. System according to claim 2, wherein the image acquiring optoelectronic means further includes a panning camera integrally coupled to the measure camera, and wherein the electronic processing means controls the first powered means first on the basis of the images acquired by the panning camera and then, once said one or more light beams appear in the images acquired by the panning camera, on the basis of the images acquired by the measure camera.

12. System according to claim 1, wherein the electronic processing means is capable to display on said display indications related to a correction of an inclination of said one or more light sources.

13. System according to claim 1, wherein the electronic processing means is capable to measure an intensity of said one or more light beams on the basis of the images acquired by the optoelectronic means.

14. System according to claim 1, wherein the electronic processing means is capable to measure an orientation of said at least one sharp colour transition in at least one of said images acquired by the optoelectronic means.

15. Process for detecting the inclination of one or more light beams, having at least one sharp colour transition, emitted by one or more light sources, in particular precision approach slope indicators, comprising the following steps:
acquiring images of said one or more light beams through optoelectronic means;
processing said images for checking whether said at least one sharp colour transition appears in at least one corresponding predetermined position thereof;
in the case where said at least one sharp colour transition does not appear in said at least one corresponding predetermined position, controlling first powered means so as to modify an inclination of the optoelectronic means; and
in the case where said at least one sharp colour transition appears in said at least one corresponding predetermined position, measuring an inclination value of the optoelectronic means.

16. Process according to claim 15, wherein it further comprises the following step:
displaying said inclination value on a display.

17. Process according to claim 15, wherein it further comprises the following preliminary step:
controlling further powered means for positioning the optoelectronic means so as to shot said one or more light beams.

18. Process according to claim 17, wherein the optoelectronic means comprises a panning camera and a measure camera, and wherein in the preliminary step images acquired by the panning camera are processed for checking that said one or more light beams appear therein, whereas the subsequent processing for checking whether said at least one sharp colour transition appears in at least one corresponding predetermined position thereof is carried out on images acquired by the measure camera.

19. Process according to claim 15, wherein it further comprises the following step:
displaying on a display indications related to a correction of an inclination of said one or more light sources.

20. Process according to claim 15, wherein it further comprises the following step:
measuring an intensity of said one or more light beams on the basis of the images acquired by the optoelectronic means.

21. Process according to claim 20, wherein the intensity of said one or more light beams is measured in a plurality of angles between the optoelectronic means and said one or more light sources, and wherein it further comprises the following step:
interpolating the intensities measured with a reference intensity diagram, preferably in proximity to said at least one sharp colour transition.

22. Process according to claim 20, wherein said light beams are at least two, and wherein it further comprises the following step:
summing the interpolated intensity diagrams of all the light beams, for obtaining an intensity diagram of said one or more light sources.

23. Process according to claim 20, wherein it further comprises the following step:
processing a width of said one or more light beams on a horizontal plane.

24. Process according to claim 15, wherein it further comprises the following step:
measuring an orientation of said at least one sharp colour transition in at least one of said images acquired by the optoelectronic means.

25. System for detecting the inclination of one or more light beams, having at least one sharp color transition, emitted by one or more light sources, in particular precision approach slope indicators, comprising;
an inclination measurer designed to measuring inclination;
image acquisition optoelectronics designed to acquire images;
a first inclinator designed to incline the image acquisition optoelectronics;
wherein the inclination measurer is mechanically coupled to image acquisition optoelectronics so as to measure the inclination of the image acquisition optoelectronics;
an electronic processing unit that controls the first inclinator on the basis of the images acquired by the image acquisition optoelectronics so that, when the system carries out a detection of the inclination of said one or more light beams, said at least one sharp color transition appears in at least one corresponding predetermined position of said acquired images, said electronic processing unit reading an inclination value outputted by the inclination measuring means for displaying the same on a display.
